(19) United States
(12) Patent Application Publication
(10) Pub. No.: US 2013/0091645 A1
(43) Pub. Date: Apr. 18, 2013

(54) Electric Toothbrush

(71) Applicant: Saksit Suwanbutr, Bangkok (TH)

(72) Inventor: Saksit Suwanbutr, Bangkok (TH)

(21) Appl. No.: 13/468,029

(22) Filed: May 9, 2012

(30) Foreign Application Priority Data
May 10, 2011 (TH) 1101000652

(51) Int. Cl. A61C 17/26

(52) U.S. Cl. CPC A61C 17/26
USPC 15/23

(57) ABSTRACT

An electric toothbrush having a central longitudinal axis is disclosed. The electric toothbrush has a brush head having a bristle roll drive shaft with a plurality of tufts of bristles radially and outwardly disposed thereon, thereby forming a bristle roll and a neck extending between the handle and the brush head. The bristle roll drive shaft and the central drive shaft are operatively connected by a belt and pulley system comprising two pulleys and a belt, and the belt and pulley system is arranged such that the bristle roll drive shaft is offset from and parallel to the central drive shaft of the neck in an eccentric-in-line position. The central drive shaft causes a one-way forward rotating motion of the bristle roll through the belt and pulley system. This rotating motion and direction imitates the brushing technique recommended by dentists to the conventional manual toothbrush users.

### BACKGROUND

An oral hygiene appliance is disclosed. More particularly, an electric toothbrush providing a motion which imitates the brushing technique of a conventional manual toothbrush used in the manner recommended by dentists is disclosed.

A manual toothbrush is an oral hygiene appliance used to remove plaque and debris from teeth and gums. The electric toothbrush or power toothbrush is an alternative oral hygiene appliance. It is convenient to use and helps users finish the cleaning process in a shorter time than a manual toothbrush. Electric toothbrushes may employ high frequency circular oscillation for brushing strokes. But dentists recommend the use of a manual toothbrush at a speed of approximately 90-120 strokes per minute. Studies have shown that a speed of approximately 90-120 brush strokes per minute is the speed used by ordinary people when brushing with a manual toothbrush.

In addition, unlike circular oscillation, the recommended brushing motion is vertically upward on the lower tooth and vertically downwardly on the upper tooth. A forward, one-way, rolling, or sweeping, motion, without back and forth motion, that starts from the gum line and moves along the vertical axis of the tooth to the tip of the tooth is recommended by dentists. The recommended brushing technique using a conventional manual toothbrush is to brush in the direction of tooth eruption on both upper and lower teeth, so the brushing direction also imitates the direction of the nature.

Various types of electric toothbrush are known in the art. For example, U.S. Pat. No. 5,625,916 shows an electric toothbrush having a motor drive for rotating a drive shaft. The drive shaft connects to a bristle holder on the head of the toothbrush in such a manner that rotation of the drive shaft causes the bristle holder to oscillate back and forth.

U.S. Pat. No. 7,594,192 discloses a powered toothbrush wherein the head of a toothbrush includes three tuft blocks. The first and the second tuft blocks have bristles mounted for counter-rotational oscillating movement in a direction parallel to the outer surface of the head. The third tuft block has bristles extending outwardly from the head to provide an extended part to support the toothpaste.

U.S. Pat. No. 7,900,309 discloses another powered toothbrush with three tuft blocks on the head. The first tuft block is mounted for rotational oscillation about an axis generally perpendicular to the outer surface of the head. The second tuft block oscillates perpendicular to the longitudinal axis of the head and in an in and out direction perpendicular to the outer surface of the head. The third tuft block is stationary.

An electric toothbrush that could clean the teeth and gums effectively and imitate the proper brushing technique recommended by dentists at a speed of approximately 90-120 strokes per minute is desirable. However, known electric toothbrushes provide a high frequency brush strokes in a circular oscillation brushing motion or a back and forth motion for the bristles. Long-term users of electric toothbrushes with high frequency oscillation have a tendency to develop tooth abrasion at the cervical portion of the teeth and gum recession at the gum margin. This tooth abrasion and/or gum recession can go on to cause tooth sensitivity.

Thus, an electric toothbrush that brushes vertically, in only one direction; with an upward and forward brushing stroke on the lower teeth and a downward and forward brushing stroke on the upper teeth; is needed. The brushing motion should not include a back and forth motion, but should follow the direction of tooth eruption. Furthermore the electric toothbrush should operate at a low frequency without causing tooth abrasion and gum recession. The electric toothbrush described herein is configured to imitate the proper brushing technique with a conventional manual toothbrush as recommended by dentists. The electric toothbrush described has a bristle roll with a vertically one-way, forward rotating motion at a low speed and following the direction of tooth eruption, thereby causing minimal damage to the teeth and gums and using proper brushing technique.

### SUMMARY

An electric toothbrush having a central longitudinal axis is disclosed. The electric toothbrush has an elongated tubular body defining a handle having a hollow cavity formed therein. A motor is disposed inside said hollow cavity. The motor includes an axially rotating motor drive shaft and a gear train having two spur gears. The first spur gear of the two spur gears is attached to a motor output drive shaft and operatively connected to a second spur gear. And the second spur gear is attached to a front end of a handle portion of a central drive shaft. The electric toothbrush also has a brush head having a bristle roll drive shaft with a plurality of bristle tufts radially and outwardly disposed thereon, thereby forming a bristle roll and a neck extending between the handle and the brush head. The handle portion of the central drive shaft is operatively connected to a neck portion of the central drive shaft. The neck portion of the central drive shaft is longitudinally disposed along the central longitudinal axis of the neck and is operatively connected to the bristle roll drive shaft at the brush head. The bristle roll drive shaft and the central drive shaft are operatively connected by a belt and pulley system comprising two pulleys and a belt, and the belt and pulley system is arranged such that the bristle roll drive shaft is offset from and parallel to the central drive shaft in an eccentric-in-line position. The central drive shaft causes a one-way forward rotating motion of the bristle roll through the belt and pulley system.

### BRIEF DESCRIPTION OF THE DRAWINGS

So that one skilled in the art will better understand how to make and use the electric toothbrush disclosed herein, preferred embodiments are described with reference to the drawings.

FIG. 1 is a perspective view of the electric toothbrush disclosed herein;

FIG. 2 is an exploded, perspective view of an electric toothbrush constructed in accordance with a preferred embodiment;

FIG. 3 is an enlarged, perspective view of the inner components of the head of the electric toothbrush shown in FIG. 1, including the belt and pulley system, and the bristle roll;

FIG. 4 is an enlarged, perspective view of a portion of the electric toothbrush shown in FIG. 1 illustrating the outer components;

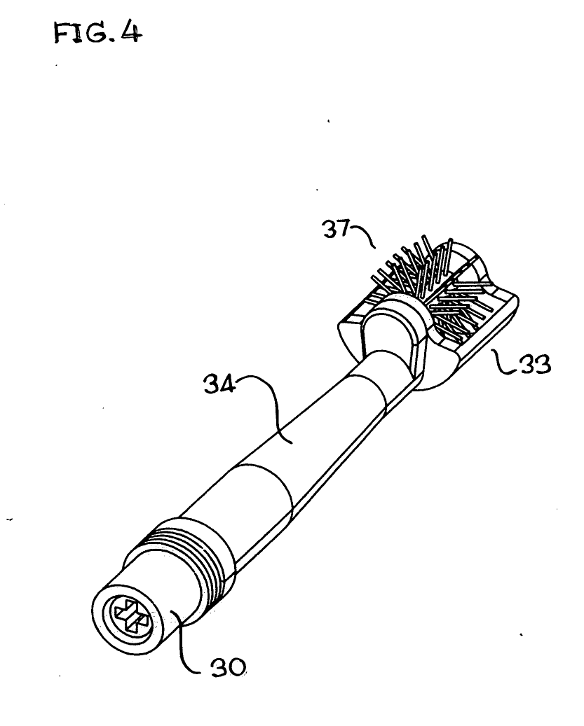

FIG. 5 is an enlarged, perspective view of the inner components of the head and neck of the electric toothbrush shown in FIG. 1;

FIG. 6 is an enlarged, exploded, perspective view of the inner components of the head and neck of the electric toothbrush shown in FIG. 1;

FIG. 7 is an enlarged, perspective view of inner components of the head and neck of the electric toothbrush shown in FIG. 1;

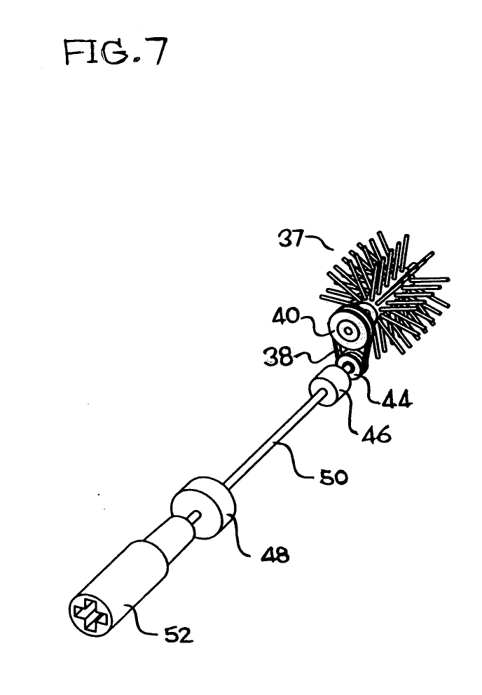

FIGS. 8a and 8b are enlarged perspective view of the electric toothbrush shown in FIG. 1 illustrating the inner and outer components;

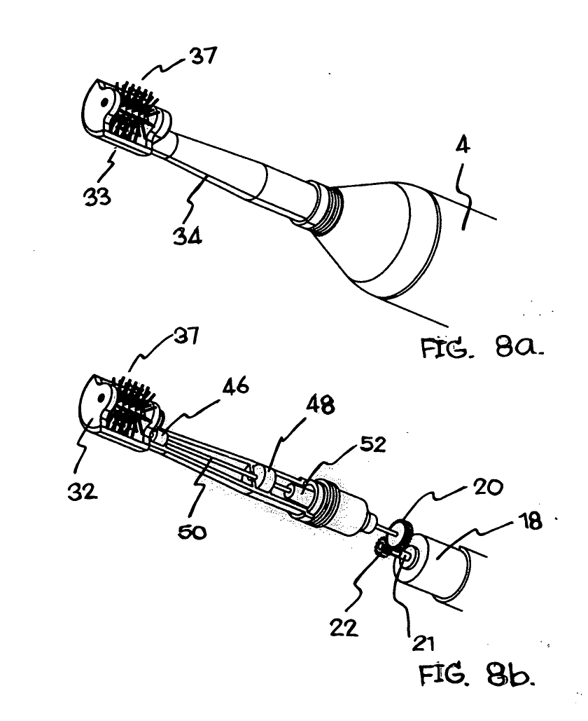

FIG. 9 is an enlarged bottom view of the inner components of the electric toothbrush head; including the tufts of bristles, the bristle roll, the bristle drive shaft, and the belt and pulley system, shown in FIG. 1;

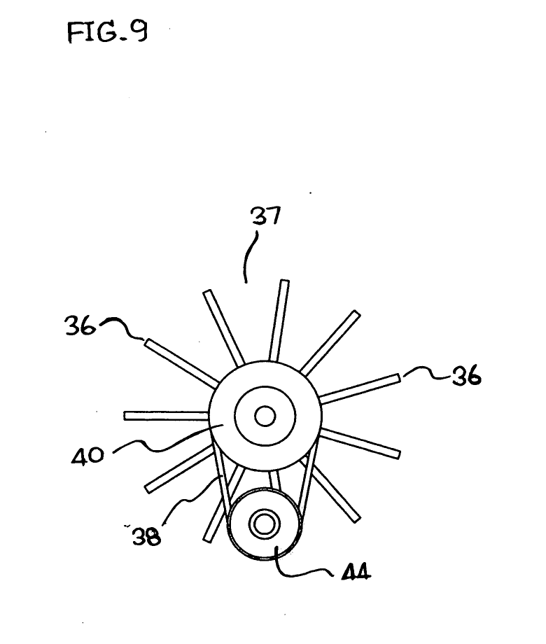

FIGS. 10a and 10b illustrate two alternate shapes for the bristle roll that may be used with the electric toothbrush shown in FIG. 1.

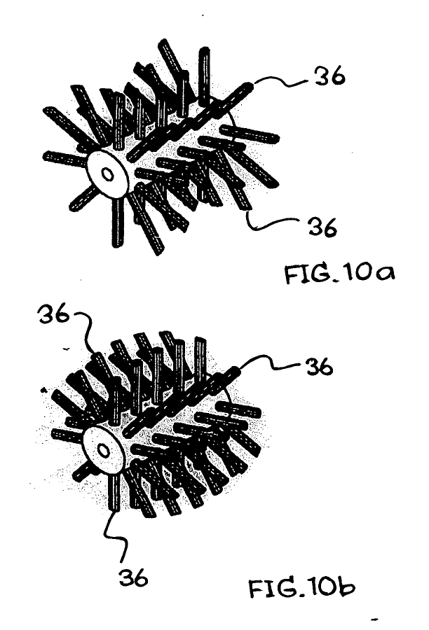

### DETAILED DESCRIPTION

The following detailed description refers the drawings. The same reference numbers in different drawings identify the same or similar parts or elements as defined by the appended claims and equivalents thereof.

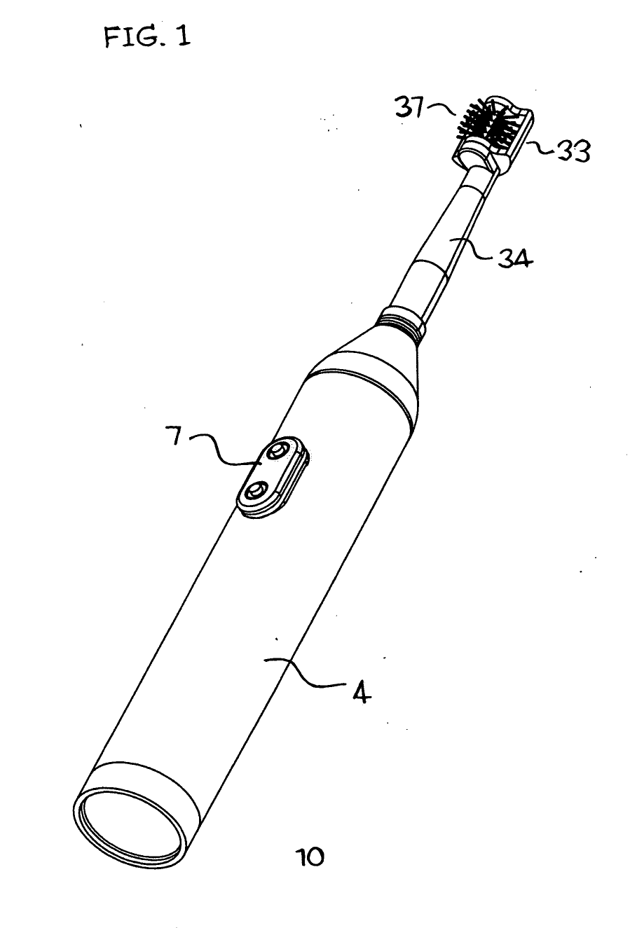

FIG. 1 illustrates one embodiment wherein an electric toothbrush 10 includes an elongated compartment defining a cylindrical, tubular, handle 4 having a motor 18 and batteries 13, 14 disposed inside. A control switch 7 is attached at the outer surface of the handle 4. The neck 34 extends between the handle 4 and the head 33. The head 33 and neck 34 may be permanently attached to the handle 4 or may be detachably attached to the handle 4. In some embodiments, the handle 4 may be designed in alternate shapes; for example the handle may have an oval tubular, flat, triangular, or square shape. The handle may have various regular or irregular shapes and/or any shape as long as the shape of the handle provides an adequate hollow cavity for disposing the operating components and has an ergonomic design to allow a convenient hand grasp.

A control switch 7 is attached on the outer surface of the handle 4 for controlling the operation of electric toothbrush 10. It is envisioned that the said control switch 7 comprises an upper button 6 and a lower button 8. The control switch 7 may be a slide switch, a push button switch, a circular switch, a touch screen control switch, a sound initiated switch and/or any type of switch or button, as long as the switch or button can control the operation of the motor 18. The control switch 7 must be able to start or to stop the motor 18, causing the motor 18 to rotate clockwise or counter clockwise, or to rotate in a continuous or an interrupted motion, or to rotate at intervals or for a set period of time, such as 5 seconds. It is to be understood, however, that the electric toothbrush disclosed herein may be used where the period of time is set to be more or less than 5 seconds. It is envisioned that the time interval or set period of time may be set in a discrete or continuous manner to achieve specific intended results.

In one embodiment the speed of the bristle roll is set to be between approximately 90 and approximately 120 strokes per minute which is sufficient to clean the teeth effectively. It is to be understood, however, that the electric toothbrush disclosed herein may also be used where the revolution of the bristle roll is set to be more than 120 strokes per minute or less than 90 strokes per minute.

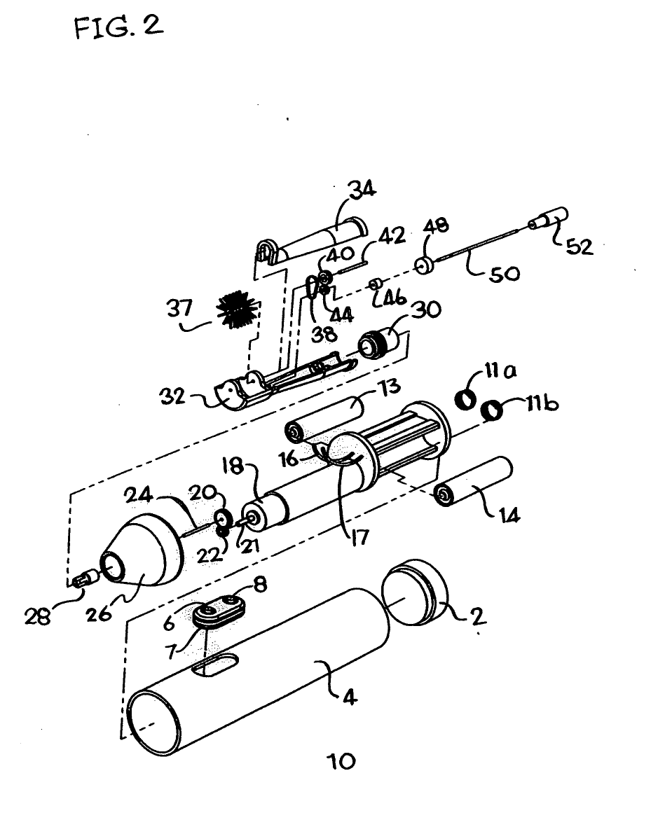

Batteries 13, 14 disposed inside the handle cavity could be rechargeable or may be disposable as long as they can power the motor 18. Control switch 7, batteries 13, 14 and motor 18 are electrically coupled to each other by an electrical circuit 16, 17. The distal end of the handle 4 may be a removable cover 2 to provide access to the batteries in some embodiments. Two small springs 11a, 11b may be used to hold the batteries 13, 14 in place within the electrical circuit 16, 17 as shown in FIG. 2.

An elongated brush support housing, the neck 34, extends between the handle 4 and the head 33 of the toothbrush 10. The bristle roll 37 is preferably formed by an elongated, cylindrical drive shaft 42 of biocompatible material having rows and columns of tufts of bristles 36 radially and outwardly disposed along the length of the bristle roll drive shaft 42. It is envisioned that the bristle roll drive shaft 42 may be varied in length, in diameter, in shape and in material composition in some embodiments. And it is envisioned that the tufts of bristles 36 may be disposed around the bristle roll drive shaft 42 at a variety of angles in some embodiments. In one embodiment, the bristle roll drive shaft 42 comprises tufts of bristles 36 all of the same height. In other embodiments, not illustrated, some of the tufts of bristles 36 may extend radially and outwardly a different distance than other tufts of bristles 36 to result in variable, stepped features on the surface of the bristle roll 37. It is thereby possible to select the combination of the bristle configurations, the tufts of bristle configurations, bristle materials, bristle stiffness and bristle orientation to achieve specific intended results, such as to create a rolling motion to imitate the proper brushing technique recommended by dentists when using a conventional manual toothbrush and to enhance the efficacy of the disclosed electric toothbrush in removing debris and plaque from the teeth, in between the teeth and at the gum margins.

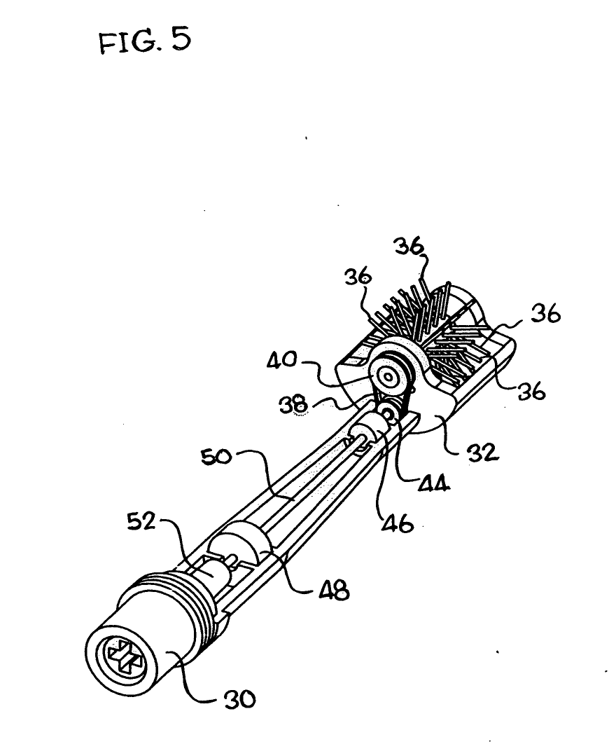

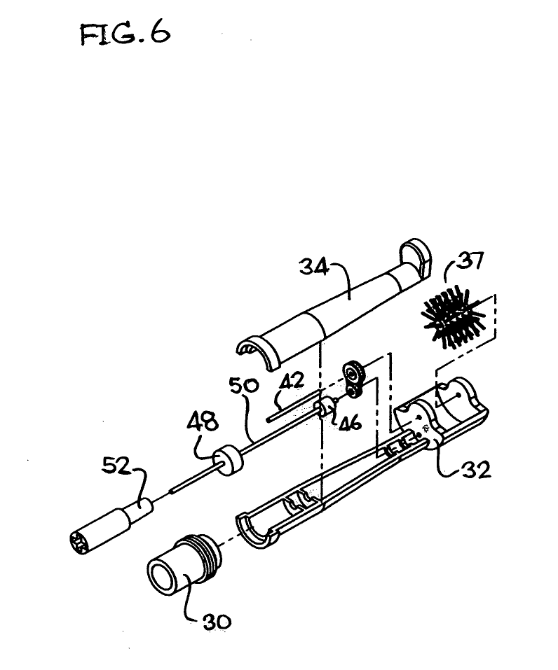

As illustrated in FIGS. 2, 5, and 6, the cover member 32 may be shaped like half of a cylinder. The cover member 32 may be formed integrally with the neck 34 and provide partial cover along the full length of bristle roll 37. The purpose of this cover member 32 is to protect the lips, the cheek, the tongue, the palate and soft tissues between the tongue and the teeth from being damaged by the operating tips of bristle during brushing. In some embodiments, the cover member 32 may be varied in shape. For example, the cover member 32 may be shaped like one third of a cylinder, two third of a cylinder, or half of a sphere. In some embodiments, the cover member 32 may be pyramidal in shape, or any shape. It is envisioned that a cover member 32 may be made from any suitable materials.

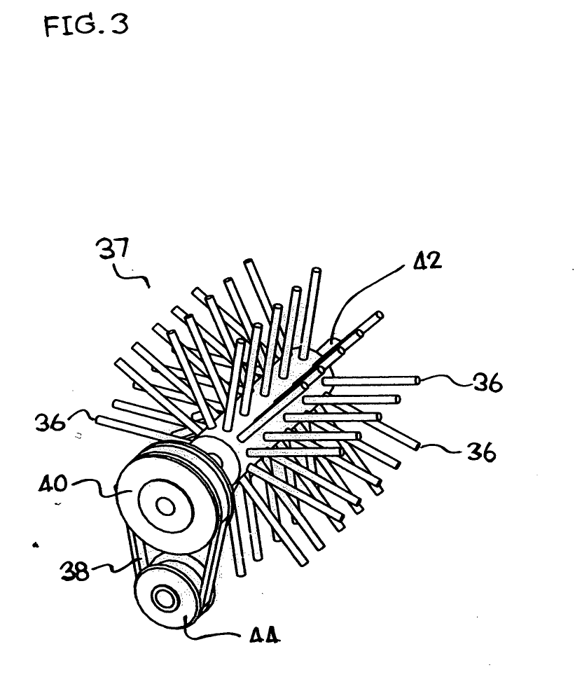

In one preferred embodiment the smaller pulley 44 attached to the distal end of the central drive shaft 50 and the bigger pulley 40 attached to the front end of the bristle roll drive shaft 42 are disposed in an eccentric-in-line position (configuration) to each other as illustrated in FIGS. 3, 5, and 6. In particular, the longitudinal central axis of the head 33 is slightly offset and parallel to the longitudinal central axis of the neck 34. Thus, the front end of the bristle roll drive shaft 42 does not meet the distal end of the central drive shaft 50. This preferred embodiment increases torque and decreases the revolution speed of the bristle roll drive shaft 42 as desired.

It is to be understood, however, that in other embodiments (not illustrated), the smaller pulley 44 and the bigger pulley 40 may be disposed in an alternated position to each other in such a manner that the smaller pulley 44 is attached to the front end of the bristle roll driven shaft 42 and the bigger pulley 40 is attached to the distal end of the central drive shaft 50. And it is to be understood that in alternate embodiments (not illustrated), both of the pulleys disposed at both of the drive shafts may have the same diameter or the same size. In some embodiments (not illustrated), the bigger pulley 40 and the smaller pulley 44 may be alternated in position to each other to increase the revolution speed and decrease the torque of the bristle roll drive shaft 42. It is to be understood, however, that the invention may also be practiced (not illustrated) where it has more than two pulleys and more than one belt 38.

The disclosed electric toothbrush 10 is characterized by the bristle roll drive shaft 42 having tufts of bristles 36 disposed radially and outwardly around and along the length of the bristle roll drive shaft 42, forming the bristle roll 37 in combination with a belt 38 and pulley 40, 44 system which is shown at the toothbrush head 33. It is to be understood; however, that the belt 38 and pulley 40, 44 system which operatively connects the distal end of the central drive shaft 50 to the front end of bristle roll drive shaft 42 could be connected at any point along the length of the bristle roll drive shaft 42. It is preferred, however, that the belt and pulley system be operatively connected to the front end of bristle roll drive shaft 42 so as to increase the clearance between the bristle roll 37 and the inner surface of the cover member 32 and to enhance the efficiency of the electric toothbrush 10.

In a preferred embodiment, the belt 38 and pulley 40, 44 system of transmission assembly comprises two pulleys 40, 44 of differing diameter and a belt 38, as illustrated in FIGS. 2, 3, and 5. In other embodiments, the transmission system may be any type of system such as a gear train of spur gear system, a chain and sprocket wheel system or any type of gears (not illustrated), etc.

The provision of the bristle roll drive shaft 42 in combination with a belt 38 and pulley 40, 44 system operatively connecting the distal end of the central drive shaft 50 to the front end of bristle roll drive shaft 42 as illustrated is also advantageous in that the position of the bristle roll 37 helps the bristle tips of the tufts of bristles 36 to reach the tooth surface during cleansing the teeth and gums which making brushing more comfortable, more practical and more acceptable to toothbrush users and dentists.

Practically and mechanically, the belt and pulley system of the disclosed electric toothbrush is used for power transmission from one shaft (the central drive shaft) to another (the bristle roll drive shaft) where slippage is admissible. In contrast, other systems, such as the sprocket and chain mechanism or the spur gear system, are used for power transmission where slippage is not admissible. This slippage phenomenon is a unique intended phenomenon the subject disclosure. The bristle roll (or the bristle roll drive shaft) will slip free from the rotating power of the central drive shaft and stop rotating if excessive force is applied to the teeth or gums during brushing. So allowing slippage is a protective mechanism which protects the teeth and gums from damage.

In a preferred embodiment, the head 33 includes a half of cylindrically-shaped cover member 32 which is configured to partially cover the length of the bristle roll 37 at the brush head 33. The cover member 32 prevents the tissue in the oral cavity such as lips, cheeks and tongue from being injured by the bristle tips of the bristle roll 37 while it rotates to clean teeth and gums. It is envisioned that the cover member 32 and the bristle roll 37 could have a variety of geometric configurations and could be interchangeable spare parts in a set of electric toothbrushes.

The handle 4 defines an elongated hollow cavity for supporting the numerous mechanical and electric parts which operate the electric toothbrush 10. In particular, the batteries 13, 14 are disposed within cavity adjacent the rear end thereof and the motor 18 is disposed in front of the batteries 13, 14. The batteries 13, 14 may be a nickel-cadmium batteries or the like. The motor 18 is preferably a low revolution D.C. motor having an armature. Conductive wires connect the batteries 13, 14 and motor 18 to the control switch 7 attached on the outer surface of the handle 4.

As illustrated in FIG. 2, the rotating power from the motor 18 is transferred along the motor drive shaft 21 to the handle portion of the longitudinal central drive shaft 24 disposed in the handle and then to the neck portion of the longitudinal central drive shaft 50. The neck portion of the longitudinal central drive shaft 50 is disposed along the longitudinal central axis of the elongated neck 34 and supported by two bushings 46, 48. The rotational power is transferred from the motor drive shaft 21 through the transmission assembly of a gear train comprising a smaller spur gear 22 attached to the output end of the motor drive shaft 21 and a bigger spur gear 20 attached to the handle portion of the longitudinal central drive shaft 24. In some embodiments the motor drive shaft 21 may be connected directly to the handle portion of the longitudinal central drive shaft 24 without any transmission assembly (not illustrated).

Preferably, the gear train of transmission assembly comprises two spur gears 22, 20 of differing diameter as illustrated in FIG. 2. However, in some embodiments the gear train may comprise more than two spur gears or it may comprise two spur gears of the same diameter (not illustrated). In some embodiments, the two spur gears 22, 20 of differing diameter may be used in the alternate position (not illustrated).

As illustrated in FIG. 2 the longitudinal central drive shaft comprises two portions including a neck portion 50 and a handle portion 24 connected to each other by a cavity jaw coupling 52 and the core jaw coupling 28. In some embodiments, the cavity jaw coupling 52 in the neck 34 is disposed inside the supporting ring 30 and the core jaw coupling 28 of the handle is disposed inside the coupling cover 26 of the handle. It is to be understood, however, that in some embodiments the neck portion of the central drive shaft 50 and the handle portion of the central drive shaft 24 may be connected to each other by any type of coupling, (not illustrated). It is envisioned that the disclosed electric toothbrush may be shaped differently, for example it may have a round-cylinder handle, oval-cylinder handle, elongated triangular-shape handle, elongated square-shape handle, etc. It is envisioned that the subject invention may be made out of different materials such as metal, rubber, woods, plastics, composites, acrylics, glass, titanium, gold, silver, alloys, polymers, elastomers and etc. And it is also envisioned that the disclosed electric toothbrush may be colored in any combination of colors. In some embodiments only one color could be used.

The electric toothbrush disclosed herein can be altered or modified by one skilled in the art without departing from the spirit of the invention. Such modification is included within the scope of the invention as set forth in the appended claims.

What is claimed is:

1. An electric toothbrush having a central longitudinal axis and comprising:
an elongated tubular body defining a handle having a hollow cavity formed therein, wherein a battery powered motor and a battery are disposed inside said hollow cavity; wherein the motor includes an axially rotating motor drive shaft and a gear train having two spur gears of differing diameter, wherein a smaller spur gear of the two spur gears is attached to a motor output drive shaft and operatively connected to a bigger spur gear, and wherein the bigger spur gear is attached to a front end of a handle portion of a central drive shaft;
a brush head having a bristle roll drive shaft with a plurality of bristle tufts radially and outwardly disposed thereon, thereby forming a bristle roll;
a neck extending between the handle and the brush head; wherein the handle portion of the central drive shaft is operatively connected to a neck portion of the central drive shaft by a core jaw coupling and a cavity jaw coupling;
wherein the neck portion of the central drive shaft is longitudinally disposed along the central longitudinal axis of the neck and is operatively connected to the bristle roll drive shaft at the brush head;
wherein the bristle roll drive shaft and the central drive shaft are operatively connected by a belt and pulley system comprising two pulleys of differing diameter and a belt, wherein the belt and pulley system is arranged such that the bristle roll drive shaft is offset from and parallel to the central drive shaft in an eccentric-in-line position; and
wherein the central drive shaft causes a one-way forward rotating motion of the bristle roll through the belt and pulley system.

2. The electric toothbrush of claim 1, wherein an outer surface of said tubular body has a switch attached thereon for controlling the motor.

3. The electric toothbrush of claim 1, wherein the speed of the bristle roll is set to be between approximately 90 and approximately 120 strokes per minute.

4. The electric toothbrush of claim 1, wherein the neck is substantially straight.

5. The electric toothbrush of claim 2, wherein the switch is configured to cause the motor to move in at least one of an interrupted motion, a continuous motion, or for a predetermined period of time.

6. The electric toothbrush of claim 1, wherein said neck portion of the central drive shaft is supported at least by two circular bushings disposed within the neck.

7. The electric toothbrush of claim 1, wherein said handle portion of the central drive shaft is detachably connected to said neck portion of the central drive shaft, such that the neck may be detached from the handle.

8. The electric toothbrush of claim 1, wherein the two pulleys of differing diameter comprise a smaller pulley having smaller diameter attached to a distal end of the central drive shaft and a larger pulley having larger diameter attached to a front end of the bristle roll drive shaft, and where the two pulleys are operatively connected by the belt.

9. The electric toothbrush of claim 8, wherein a distance between the two pulleys is a predetermined distance.

10. The electric toothbrush of claim 1, wherein the two pulleys of differing diameter comprise a bigger pulley having bigger diameter attached to a distal end of the central drive shaft and a smaller pulley having smaller diameter attached to a front end of the bristle roll drive shaft, and where the two pulleys are operatively connected by the belt.

11. The electric toothbrush of claim 1, wherein the neck is bent at an angle.

12. The electric toothbrush of claim 7, wherein said pulleys may be smooth or may be a drum-style pulley without a groove or flanges or may be a slightly concave pulley or may be a u-shaped or a v-shaped pulley, or may be any type of pulley.

13. The electric toothbrush of claim 7, wherein said pulleys have at least one groove.

14. The electric toothbrush of claim 2, wherein the switch is configured to control the motor's direction of rotation, thereby causing the motor to rotate clockwise or counter clockwise.

15. The electric toothbrush of claim 1, wherein bristles in the bristle tufts have at least one predetermined shape, said predetermined shape comprising a round-ended taper, a sharp-ended taper, a round-ended cylinder, a sharp-ended cylinder, or a flat sheet-like shape.

16. The electric toothbrush of claim 1, wherein said bristle roll is formed in a predetermined shape, said predetermined shape one of a cylindrical shape, a concave shape, a convex shape, a triangular shape, a spiral shape, a ball shape, or an irregular shape.

17. The electric toothbrush of claim 1, wherein bristles of said bristle tufts have at least one predetermined shape, said predetermined shape comprising a round-ended taper, a sharp-ended taper, a round-ended cylinder, a sharp-ended cylinder, a square-ended tubular shape, or a flat sheet-like shape.

18. An electric toothbrush having a central longitudinal axis and comprising:
an elongated tubular body defining a handle having a hollow cavity formed therein, wherein a motor is disposed inside said hollow cavity; wherein the motor includes an axially rotating motor drive shaft and a gear train having two spur gears, wherein a first spur gear of the two spur gears is attached to a motor output drive shaft and operatively connected to a second spur gear, and wherein the second spur gear is attached to a front end of a handle portion of a central drive shaft;
a brush head having a bristle roll drive shaft with a plurality of bristle tufts radially and outwardly disposed thereon, thereby forming a bristle roll;
a neck extending between the handle and the brush head; wherein the handle portion of the central drive shaft is operatively connected to a neck portion of the central drive shaft;
wherein the neck portion of the central drive shaft is longitudinally disposed along the central longitudinal axis of the neck and is operatively connected to the bristle roll drive shaft at the brush head;
wherein the bristle roll drive shaft and the central drive shaft are operatively connected by a belt and pulley system comprising two pulleys and a belt, wherein the belt and pulley system is arranged such that the bristle roll drive shaft is offset from and parallel to the central drive shaft in an eccentric-in-line position; and
wherein the central drive shaft causes a one-way forward rotating motion of the bristle roll through the belt and pulley system.

19. The electric toothbrush of claim 18, wherein said pulleys have substantially the same diameter.

20. The electric toothbrush of claim 18, wherein said spur gears have substantially the same diameter.
